(19) United States
(12) Patent Application Publication
(10) Pub. No.: US 2008/0055363 A1
(43) Pub. Date: Mar. 6, 2008

(54) Large area array print head

(75) Inventor: Stanley W. Stephenson, Spencerport, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/516,064

(22) Filed: Sep. 6, 2006

(51) Int. Cl. B41J 2/04

(52) U.S. Cl. 347/54

(57) ABSTRACT

A print head includes a substrate; and a plurality of ejectors arranged on the substrate in rows and laterally staggered columns, each of the plurality of ejectors includes a chamber including a nozzle; a resistive element associated with the chamber operable to eject liquid from the chamber through the nozzle of the chamber; and a supply passage through the substrate, the supply passage being dedicated to the ejector.

### CROSS REFERENCE TO RELATED APPLICATIONS

Reference is made to commonly-assigned, U.S. patent application Ser. No. ______ (Kodak Docket No. 93009), filed concurrently herewith, entitled “LARGE AREA ARRAY PRINT HEAD EJECTOR ACTUATION” in the name of Stanley W. Stephenson, the disclosure of which is incorporated herein by reference.

### FIELD OF THE INVENTION

This invention relates generally to the field of digitally controlled printing devices, and in particular to large area array print heads in which a plurality of ejectors are arranged in rows and columns.

### BACKGROUND OF THE INVENTION

Ink jet printing systems apply ink to a substrate. The inks are typically dyes and pigments in a fluid. The substrate can be comprised of an material or object. Most typically, the substrate is a flexible sheet which can be a paper, polymer or a composite of either type of material. The surface of the substrate and the ink are formulated to optimize the ink lay down.

Ink drops can be applied to the substrate by modulated deflection of a stream of ink (continuous) or by selective ejection from a drop generator (drop-on-demand). The drop-on-demand (DOD) systems eject ink using either a thermal pulse delivered by a resistor or a mechanical deflection of a cavity wall by a piezoelectric actuator. Ejection of the droplet is synchronized to motion of the substrate by a controller, which selectively applies an electrical signal to each ejector to form an image.

U.S. Pat. No. 6,491,385 describes a continuous ink jet head and it's operation. A silicon substrate supports layers on the front surface having a pair of resistive elements. A bore through the silicon substrate is supplied for each nozzle. A fluid, which can be ink, is forcibly ejected through the bore and through a nozzle formed in the layers on the front surface. The resistors are modulated to break the stream of fluid into discrete droplets. Asymmetric heating of the resistors can selectively direct the droplets into different pathways. A gutter can be used to filter out select droplets, providing a stream of selectable droplets useful for printing. The modulated stream printing system requires significant additional apparatus to manage fluid flow.

Piezoelectric actuated heads use an electrically flexed membrane to pressurize a fluid containing cavity. The membranes can be oriented in parallel or perpendicular to the ejection direction. U.S. Pat. No. 6,969,158 describes a piezoelectric drop-on-demand ink jet head having the membrane perpendicular to the droplet ejection direction. A set of plates is stacked up and includes plate of piezoelectric which flexes a pressure chamber parallel to the direction of ink ejection. The membranes require a large amount of surface area, and multiple rows of ejectors are arrayed in depth across the head. Ejectors are arranged across the printing direction at a pitch of 50 dpi and are arrayed in the printing direction 12 ejectors deep on an angle theta to form a head having an effective pitch of 600 dpi. Such heads are complex, requiring multiple layers that must be bonded together to form passages to the nozzle.

U.S. Pat. No. 6,926,284 discloses a drop-on-demand inkjet head permitting single-pass printing. A single pass print head comprises 12 linear array module assemblies which are attached to a common manifold/orifice plate assembly. The orifice plate is driven by twelve staggered linear array assemblies which support piezoelectric body assemblies to provide drop-on-demand ejection of ink through the orifice array. The piezoelectric system cannot pitch nozzles closely together; in the example, each swath module has a pitch of 50 dpi. The twelve array assemblies are combined to provide 600 dpi resolution in a horizontally and vertically staggered fashion.

The orifice array on the plate can be a single two-dimensional array of orifices or a combination of orifices to form an array of nozzles. In the printing application, the orifices must be positioned such that the distance between orifices in adjacent line is at last an order of magnitude (more than ten times) the pitch between print lines. The assembly is quite complex, requiring many separate array assemblies to be attached to the orifice plate thorough the use of sub frames, stiffeners, clamp bar, washers and screws.

It would be advantageous to provide a staggered array in a unitary assembly with an integral orifice plate. It would be useful for the spacing between nozzles to be less than an order of magnitude deeper than is disclosed in the patent.

U.S. Pat. No. 6,722,759 describes a common thermal drop-on-demand inkjet head structure. The drop generator consists of ink chamber, an inlet to the ink chamber, a nozzle to direct the drop out of the cavity and a resistive element for creating an ink ejecting bubble. Linear arrays of drop generators are positioned on either side of an ink feed slot. Two linear arrays are fed by a common ink feed slot. Ink from the slot passes through a flow restricting ink channels to the ink chamber. A heater resistor at the bottom of the ink chamber is energized to form a bubble in the chamber and eject a drop of ink through a nozzle in the top of the chamber. The ejectors are constrained to be in linear rows on either side of the ink jet supply slot.

U.S. Pat. No. 6,367,903 discloses a similar structure. The arrays of drop generators are not in a strictly linear fashion, but are slightly offset in groups of three and four generators. Generators in a group are displaced sequentially farther from the supply slot within a group. Adjacent nozzles between the groups have a maximum variation in distance from the common supply slot.

EP 1,563,999 A2 discloses two linear rows of nozzles on a common supply slot. The ejectors in this patent are arranged in triplets, which are sequentially moved further from the supply slot. The triplets have a large offset between nozzles at the boundary between each triplet. U.S. Pat. No. 6,932,453 discloses an ink jet head with ejectors arranged in a matrix having a print width depth and multiple columns of depth. The columns consist of pairs of linearly arrayed ejectors sharing a common feed slot.

U.S. Pat. No. 5,134,425 discloses a passive two dimensional array of heater resistors. The structure and arrangement of the droplet generators is not disclosed. The patent discloses the problem of power cross-talk between resistors in two dimensional arrays of heater resistors. Voltages firing a resistor also apply partial voltages across unfired resistors. The parasitic voltage increases as the number of rows is increased to 5 rows. The patent applies partial voltages on certain lines to reduce the voltage cross talk. The partial energy does not eject a droplet, but maintains a common elevated temperature for both fired and unfired nozzles. The patent covers print head arrays having limited numbers of rows.

It would be useful to have a structure for an inkjet head which dispersed the nozzles in a an array structure useful for high speed printing. It would be useful for the structure to have minimal sensitivity to nozzle offset error.

### SUMMARY OF THE INVENTION

It is an object of this invention to provide an ink ejecting head having a large array of ejectors. Individual ejector assemblies are dispersed in width and depth across the substrate. Ejectors are self contained, and each has an individual supply port through the substrate. Ejectors are arrayed in a “W” pattern which minimizes the variation in depth between adjacent ejectors.

Accordingly, one aspect of the present invention includes a print head comprising a substrate; and a plurality of ejectors arranged on the substrate in rows and laterally staggered columns, each of the plurality of ejectors comprising: a chamber including a nozzle; a resistive element associated with the chamber operable to eject liquid from the chamber through the nozzle of the chamber; and a supply passage through the substrate, the supply passage being dedicated to the ejector.

Another aspect of the present invention includes a method of forming a print head comprising: providing a substrate; and forming a plurality of ejectors arranged on the substrate in rows and laterally staggered columns, each of the plurality of ejectors comprising: a chamber including a nozzle; a resistive element associated with the chamber operable to eject liquid from the chamber through the nozzle of the chamber; and a supply passage formed through the substrate, the supply passage being dedicated to the ejector.

### BRIEF DESCRIPTION OF THE DRAWINGS

In the detailed description of the example embodiments of the invention presented below, reference is made to the accompanying drawings, in which:

FIG. 1 is a top schematic view of an ejector in accordance with the present invention;

FIG. 2 is a side sectional view through the ejector shown in FIG. 1;

FIG. 3 is a top view of an array of ink ejectors according to prior art;

FIG. 4 is a top view of a second embodiment of ejectors in accordance with prior art;

FIG. 5 is a top schematic view of an ejector in accordance with the present invention;

FIG. 6 is a schematic representation of an ejector array in accordance one example embodiment of the invention;

FIG. 7 is a schematic representation of an ejector array in accordance another example embodiment of the invention;

FIG. 8 is an electrical schematic of an ink jet head in accordance with the present invention;

FIG. 9 is a schematic view of a head assembly in accordance with the present invention; and

FIG. 10 is a side view of a printer using a head in accordance with the present invention.

### DETAILED DESCRIPTION OF THE PREFERRED EMBODIMENT

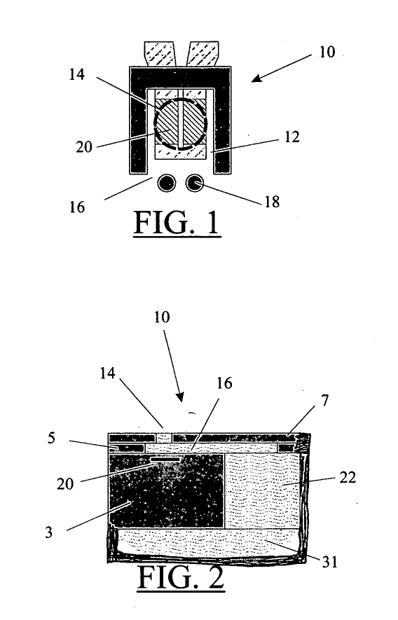

FIG. 1 is a top schematic view of an ejector 10 in accordance with the present invention. FIG. 2 is a side sectional view through the ejector shown in FIG. 1. A substrate 3 supports a polymer layer 5. Substrate 3 can be a monolithic substrate, for example, a single crystal silicon wafer. Alternatively, substrate 3 can be other monolithic structures, for example, glass, a metal such as stainless steel or nickel, a sintered material like microcrystalline silicon, Invar, or a polymer such as polyimide. An ink chamber 12 is formed as a cavity in polymer layer 5 to hold a printing ink. A cover 7 over ink chamber 12 can be formed directly over polymer layer 5 using a vacuum deposited ceramic or metal. Cover 7 over ink chamber 12 can also be a separate plate formed of ceramic or metal which is bonded to the polymer layer 5 defining ink chamber 12. Cover 7 has an opening to form a nozzle to direct an ejected droplet of ink in a specified direction when ink chamber 12 is pressurized.

A heater resistor 20 is embedded in the substrate 3. A pulse of electrical energy to heater resistor 20 causes ink within ink chamber 12 to momentarily be converted into a gaseous state. A gas bubble is formed over heater resistor 20 within ink chamber 12, and pressurizes ink chamber 12. Pressure within ink chamber 12 acts on ink within ink chamber 12 and forces a droplet of ink to be ejected through nozzle 14. Inlet 16 supplies ink to ink chamber 12. Restriction 18 can be formed at inlet 16 to improve firing efficiency by restricting the majority of the pressure pulse to ink chamber 12. Restriction 18 can be in the form of one or more pillars formed within inlet 16, or by a narrowing of the side walls in polymer layer 5 at inlet 16 of ink chamber 12.

Resistive heads are commonly made using silicon for substrate 3. Heater resistor 20 and associated layers are formed over substrate 3, followed by polymer layer 5. Polymer layer 5 is patterned, followed by over 7, which is patterned to form nozzle 14. After those layers have been formed, ink feed slot 22 is formed through substrate 3 using a reactive ion milling process. The reactive ion milling process has the characteristic of forming near-vertical walls through a silicon substrate 3. The ion milling process has the virtue that the process is specific to silicon and can be form ink feed slot 22 without damage to structures associated with ejectors 10 on substrate 3. Substrate 3 is bonded to a structure which has one or more cavities in head holder 31 for supplying ink to some or all of ejectors 10 formed on substrate 3. Each ejector 10 is fed by a cavity of head holder 31 through its dedicated supply passage 22. Each supply passage 22 is associated with an individual ejector 31 and is physically separated from other ejectors 10 by material forming substrate 3.

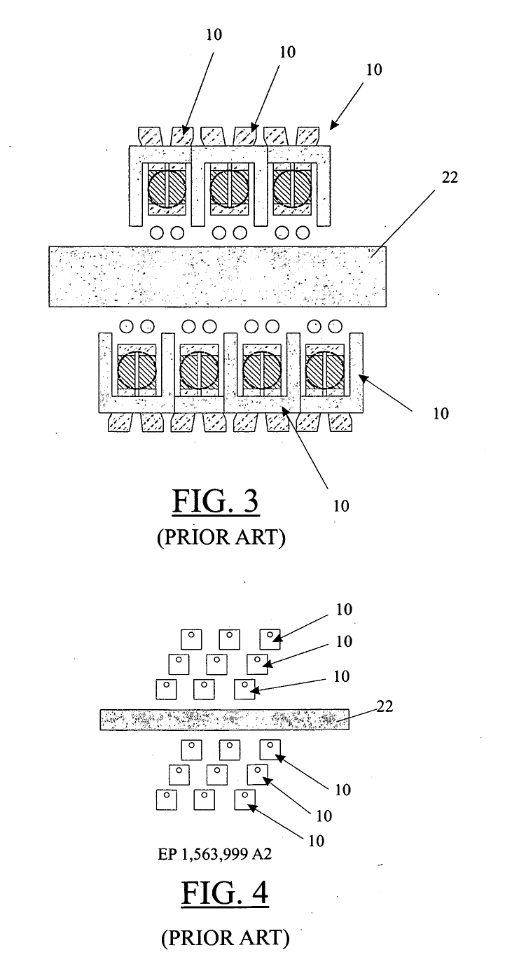

FIG. 3 is a top view of an array of ink ejectors according to prior art. Ejectors 10 must be supplied by ink from the rear side of substrate 3. U.S. Pat. No. 6,722,759 describes how ink is currently supplied in thermal drop-on-demand inkjet heads. Ejectors 10 are arranged in two closely packed rows which share a common ink feed slot 22. Ink feed slot 22 passes through substrate 3, which supports ejectors 10. FIG. 4 is a top view of a second embodiment of ejectors in accordance with prior art as disclosed in EP 1,563,999 A2. In that patent, a common ink feed slot 22 supplies ejectors 10. Ejectors 10 are not in a strictly linear row, but are progressively offset depth wise in groups of three ejectors.

Arranging two linear rows of ejectors 10 on either side of ink feed slot 22 provides for a compact ink jet head. Because the nozzles are adjacent to each other, fluidic cross-talk can occur between the ejectors. Close packing of the nozzles makes the head susceptible to thermal cross-talk between adjacent nozzles. Overheating can become more pronounced if substrate 3 is not silicon, but a less thermally conductive material such as glass, ceramic or metal.

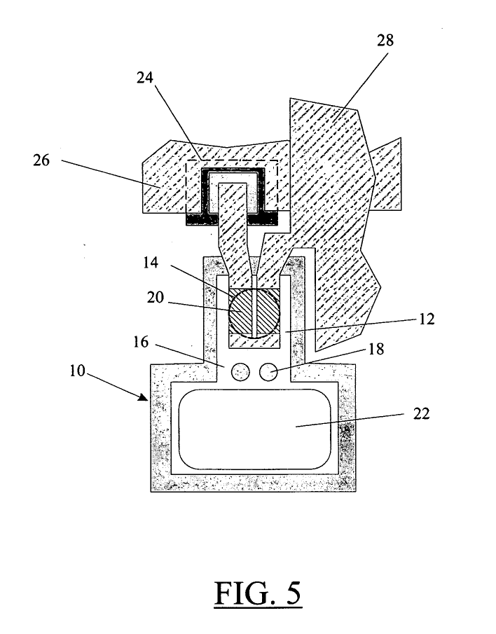

FIG. 5 is a top schematic view of an ejector in accordance with the present invention. In the invention, an ejector 10 comprises an ink chamber 12 actuated by heater resistor 20. Ink chamber 12 is fed by inlet 16 and ejects fluid through nozzle 14. A restriction 18 can be formed at the inlet to improve ejector 10's performance. A dedicated supply passage 22, for example, an ink feed slot, is integral with ejector 10. In the case that substrate 3 is made of silicon, the ability of reactive ion etching process to form substantially columnar individual supply passages 22 to be formed through substrate 3. Each supply passage 22 shares a common head holder 23 supplied on the back of substrate 3. Ejector 10 in accordance with the invention provides a complete assembly that can be positioned at greater distance from adjacent ejectors 10 to eliminate fluidic cross talk and improve cooling efficiency. In the case that substrate 3 is not silicon, the greater distance prevents overheating that would result from closely spaced ejectors 10 on lower conductivity substrates 3. Sufficient spacing between ejectors 10 further permits the use of anisotropic etching in non-silicon substrates.

U.S. Pat. No. 5,134,425 discloses a passive two dimensional array of heater resistors. The patent discloses the problem of power cross-talk between resistors in two dimensional arrays of heater resistors. Voltages used to fire a given resistor applies partial voltages across unfired resistors, significantly increasing the current and power demand. In FIG. 5, ejector 10 is connected to row conductor 26 and column conductor 28. A diode 24 permits multiple ejectors 10 to be attached to a matrix of row conductors 26 and column conductors 28. The diodes block current flows to parasitic elements, reducing power demand of the device. The diodes permit large number of columns to be used on the head. The larger number of columns permit heads with finer resolution and greater spacing between ejectors 10.

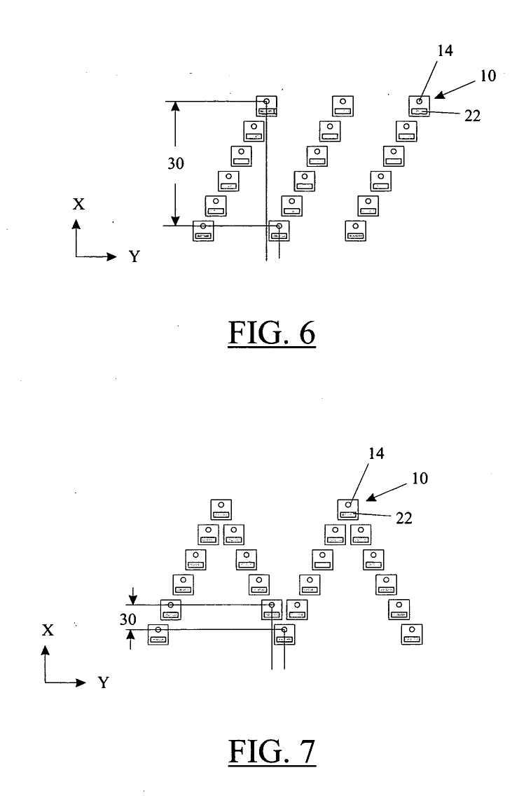

FIG. 6 is a schematic representation of an ejector array in accordance one example embodiment of the invention. A coordinate system is shown and includes a first direction X with X an axis of motion between the printhead and an ink receiving surface. This is commonly referred to as a printing direction. A second direction Y is also shown with Y being a cross printing direction. A direction Z is also shown with Z being a direction perpendicular to the printhead. This is commonly referred to as the direction of ink drop ejection from the printhead.

Ejectors 10 are shown schematically as a box having individual supply ports 22 and ejectors 14. Ejectors 10 have been attached to a matrix of row conductors 26 and column conductors 28 to form laterally staggered columns of ejectors 10. All ejectors 10 are positioned on a single substrate 3. Each ejector 10 of a column of ejectors is staggered at a desired pitch, typically expressed in dpi or microns, which is finer than the pitch of the ejector columns. For example, each column can be pitched 600 microns apart due to the area required for each ejector. If the required printing pitch is 40 microns, each ejector in the column can be laterally staggered 40 microns to a depth of 15 ejectors (40×15=600) to achieve the required 40 micron printing pitch.

In FIG. 6, six ejectors are shown in each laterally staggered column, however, each laterally staggered column can include more than six ejectors or less than six ejectors. The lateral staggering at a given number of levels provides room for each ejector 10 at high lateral resolution. This pattern includes a relatively large spacing distance 30 between adjacent columns—the last ejector of a group and the first ejector of the following group. The relatively large spacing distance 30 may require precise-orientation of the print head having such spacing to the axis of motion of the print head relative to an ink receiver 40. If the orientation is off-axis by too much of an angle, either an unprinted line or double hit line will occur while printing.

FIG. 7 is a schematic representation of an ejector array in accordance another example embodiment of the invention. In FIG. 7, ejectors 10 are arranged to a given depth, for example, six deep, and maintain a minimal spacing distance 30 between ejectors. All ejectors 10 are positioned on a single substrate 3. In addition to being laterally staggered, the ejectors form a zigzag pattern which follows a course that includes at least one turn in alternating direction. Typically, the at least one turn occurs for nozzles subsequent to nozzles at either extreme end of depth.

This pattern reduces the accuracy requirements for rotational alignment of the print head, thereby reducing errors during printing. Rotation of the print head around the z axis can result in banding during printing. Minimizing spacing distance 30 reduces the requirements for accuracy of the rotational alignment requirements for the printhead.

The embodiments shown in FIGS. 6 and 7 are particularly well suited for print heads having large area arrays, for example, print heads having a length dimension of four inches and a width dimension of one inch. However, the large area array print head can have other length and width dimensions. One (or a plurality of large area array print heads stitched together) can be used to form a pagewide print head.

In a pagewide print head, the length of the printhead is preferably at least equal to the width of the receiver and does not “scan” during printing. The length of the page wide printhead is scalable depending on the specific application contemplated and, as such, can range from less than one inch to lengths exceeding twenty inches.

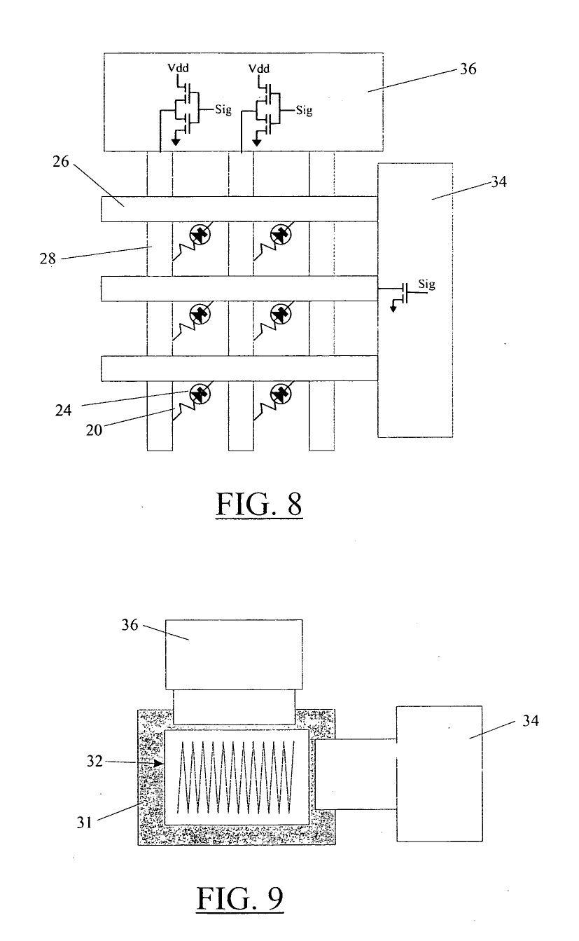

FIG. 8 is an electrical schematic of an ink jet head in accordance with the present invention. Print head 32 has column conductors 28 connected to column driver 36. Column driver 36 can be a ST Microelectronics STV 7612 Plasma Display Panel Diver which is connected to row conductor column conductors 28. The chip responds to digital signals to either apply a drive voltage or ground to each column conductors. Each row conductor 26 is connected to a row driver 34. Row driver 34 can be a ST Microelectronics L6451 28 Channel Ink Jet Driver which provides a DMOS power transistor to each row conductor 26. Diode 24, provided with each ejector 10, provides logic to permit print head 32 to be logically driven in a sequential column wise fashion.

Print head 32 is fired row sequentially. Row driver 34 applies a ground voltage to a written row. Digital signals apply a drive voltage (Vdd) or ground voltage to each row conductor 28. Row conductors 28 having an applied drive voltage provide energy to the ejector attached to column conductor 28 and the grounded row conductor 26. Row conductors 28 having a ground voltage are not fired. Only one row conductor 26 at a time has a ground voltage, the other row conductors are attached to high impedance drivers and cannot fire. Row conductors 26 are fried in a sequential manner, and column conductors 36 are set to a state that corresponds to a row of ejectors being fired or not fired. After all rows have been written, all ejectors are fired and the process is repeated to apply an image wise pattern of ink droplets from print head 32.

FIG. 9 is a schematic view of a head assembly in accordance with the present invention. Substrate 3 has been mounted to a head holder 31, which holds a supply of ink behind substrate 3 to supply ink through substrate to ejectors mounted on the front of substrate 3. Row driver 34 and column driver 36 are attached to head holder 31 and wire bonds made between the flex circuit for the drivers to the row and column conductors on print head 32.

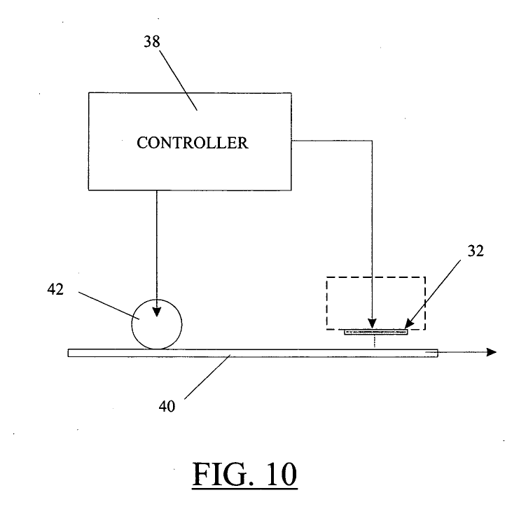

FIG. 10 is a schematic side view of a printer using a head in accordance with the present invention. Controller 38 moves an ink receiver 40 using receiver driver 42. Receiver driver 42 is a motor which operates on a plate or roller to drive ink receiver 40 under print head 32. Controller 38 provides drive signals to row driver 34 and column driver 36 connected to print head 32 to apply an image-wise pattern of ink droplets onto ink receiver 40 in synchronization with the motion of ink receiver 40.

The invention has been described in detail with particular reference to certain preferred embodiments thereof, but it will be understood that variations and modifications can be effected within the spirit and scope of the invention.

### PARTS LIST

3 substrate
5 polymer layer
7 cover
10 ejector
12 ink chamber
14 nozzle
16 inlet
18 restriction
20 heater resistor
22 ink feed slot
23 head holder
24 diode
26 row conductor
28 column conductor
30 spacing distance
31 head holder
32 print head
34 row drivers
36 column drivers
38 controller
40 ink receiver
42 receiver driver

What is claimed is:

1. A print head comprising:
a substrate; and
a plurality of ejectors arranged on the substrate in rows and laterally staggered columns, each of the plurality of ejectors comprising:
a chamber including a nozzle;
a resistive element associated with the chamber operable to eject liquid from the chamber through the nozzle of the chamber; and
a supply passage through the substrate, the supply passage being dedicated to the ejector.

2. The print head of claim 1, wherein the plurality of ejectors arranged on the substrate in rows and laterally staggered columns form a course that includes at least one turn in an alternating direction.

3. The print head of claim 1, wherein each dedicated supply passage shares a head holder with other supply passages.

4. The print head of claim 1, wherein the substrate is silicon.

5. The print head of claim 1, wherein the substrate is a monolithic substrate.

6. A method of forming a print head comprising:
providing a substrate; and
forming a plurality of ejectors arranged on the substrate in rows and laterally staggered columns, each of the plurality of ejectors comprising:
a chamber including a nozzle;
a resistive element associated with the chamber operable to eject liquid from the chamber through the nozzle of the chamber; and
a supply passage formed through the substrate, the supply passage being dedicated to the ejector.

7. The method of claim 6, wherein the substrate is silicon.

8. The method of claim 7, wherein the each supply passage is formed using a reactive ion etching process to create a substantially columnar supply passage through the silicon substrate.
